(19) United States
(12) Patent Application Publication
(10) Pub. No.: US 2015/0339301 A1
(43) Pub. Date: Nov. 26, 2015

(54) METHODS AND SYSTEMS FOR MEDIA SYNCHRONIZATION

(71) Applicant: Syn Holdings LLC, Los Angeles, CA (US)

(72) Inventors: Whitney Richard Paalborg, Los Angeles, CA (US); Brian Paulherman Hammons, Los Angeles, CA (US)

(73) Assignee: Syn Holdings LLC, Los Angeles, CA (US)

(21) Appl. No.: 14/282,187

(22) Filed: May 20, 2014

(51) Int. Cl. G06F 17/30; G06F 3/0484

(52) U.S. Cl. CPC G06F 17/30058; G06F 3/04842

(57) ABSTRACT

Systems and methods are provided for generating visualizations. A user interface may be provided enabling a user to indicate on which set of networked devices a visualization is to be played by, wherein the user can selectively specify that the visualization is to be displayed on a plurality of networked devices or on a single device. A set of devices is selected that the visualization is to be displayed on based at least in part on a user specification provided via the user interface. The visualization is caused to be displayed on the set of user devices, wherein the synchronization of images included in the visual media with the music is based at least in part on: a genre classification of the music and/or a genre classification of the images.

### BACKGROUND OF THE INVENTION

1. Field of the Invention

The present invention relates to methods and systems for media synchronization.

2. Description of the Related Art

Many conventional visualizers merely synchronize computer generated imagery, displayed on a user's computer system, with an item of music selected by the user. For example, the computer generated imagery may be generated in real time based on the music's characteristics, such as its loudness level and frequency spectrum. However, conventional visualizers tend to be insufficiently involving, as well as being visually distracting and unrelated to a user's current activities or mood, to warrant sustained engagement with a user.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An aspect of the disclosure is a computer-implemented method of providing visualizations, the method comprising: identifying a first user; accessing profile information for the identified first user; determining which user-specified sensor data is to be used in generating or modifying a first visualization comprising synchronized visual media and music, wherein the visual media comprises one or more pre-existing images stored in remote or local non-transitory memory; providing a first user interface enabling the first user to indicate on which of a set of networked devices the first visualization is to be played by, wherein the user can selectively specify that the first visualization is to be displayed on a plurality of networked devices or on a single device; identifying a set of devices that the first visualization is to be displayed on based at least in part on a user specification provided via the first user interface; wherein the first visualization is selected or generated at least partly in response to the first user profile information; causing the first visualization to be displayed on the set of user devices, wherein the synchronization of images included in the visual media with the music is based at least in part on: a genre classification of the music, or a genre classification of the images, or both a genre classification of the music and a genre classification of the images; and on a determined audio structure of the music; and receiving the sensor data specified by the user; dynamically modifying or generating the first visualization based at least in part on the sensor data specified by the user.

An aspect of the disclosure is a computer-implemented method of providing visualizations, the method comprising: providing a first user interface enabling a first user to indicate on which of a set of networked devices a first visualization is to be presented by, wherein the user can selectively specify that the first visualization is to be presented on a plurality of networked devices or on a single device; identifying a set of devices that the first visualization is to be presented on based at least in part on a user specification provided via the first user interface; causing the first visualization to be presented on the set of user devices, wherein the synchronization of images included in the visual media with the music is based at least in part on: a genre classification of the music, or a genre classification of the images, or both a genre classification of the music and a genre classification of the images; and on a determined audio structure of the music.

An aspect of the disclosure is system comprising: a data store configured to store computer-executable instructions; and a processor comprising hardware in communication with the data store, the processor configured to execute the computer-executable instructions to at least: provide a first user interface enabling a first user to indicate on which of a set of networked devices a first visualization is to be presented by, wherein the user can selectively specify that the first visualization is to be presented on a plurality of networked devices or on a single device; identify a set of devices that the first visualization is to be presented on based at least in part on a user specification provided via the first user interface; cause the first visualization to be presented on the set of user devices, wherein the synchronization of images included in the visual media with the music is based at least in part on: a genre classification of the music, or a genre classification of the images, or both a genre classification of the music and a genre classification of the images; and on a determined audio structure of the music.

An aspect of the disclosure is system comprising: a data store configured to store computer-executable instructions; and a processor comprising hardware in communication with the data store, the processor configured to execute the computer-executable instructions to at least: cause the first visualization to be presented on a set of user devices, wherein the synchronization of images included in the visual media with the music is based at least in part on: a genre classification of the music, or a genre classification of the images, or both a genre classification of the music and a genre classification of the images.

An aspect of the disclosure is a non-transitory computer-readable storage medium storing computer executable instructions that when executed by a processor perform operations comprising: providing a first user interface enabling a first user to indicate on which of a set of networked devices a first visualization is to be presented by, wherein the user can selectively specify that the first visualization is to be presented on a plurality of networked devices or on a single device; identifying a set of devices that the first visualization is to be presented on based at least in part on a user specification provided via the first user interface; causing the first visualization to be presented on the set of user devices, wherein the synchronization of images included in the visual media with the music is based at least in part on: a genre classification of the music, or a genre classification of the images, or both a genre classification of the music and a genre classification of the images; and on a determined audio structure of the music.

### BRIEF DESCRIPTION OF THE DRAWINGS

Embodiments will be described with reference to the drawings summarized below. These drawings and the associated description are provided to illustrate example embodiments, and not to limit the scope of the invention.

FIG. 1 illustrates an example architecture.

FIGS. 2A-F illustrate example user interfaces

FIG. 3 illustrates an example process.

### DETAILED DESCRIPTION

As similarly discussed above, many conventional visualizers tend to be insufficiently involving, as well as being visually distracting and unrelated to a user's current activities or mood, to warrant sustained engagement with a user.

Disclosed herein are various embodiments of methods and systems for media synchronization that provide a more engaging and interactive experience than such conventional visualizers and provide a more pleasing visual and audio “atmosphere,” where, for example, the visual and audio components are synchronized (although the video and audio components may be from different, unrelated sources). For example, the media may include audio media, such as music, speech, sounds from nature, white noise, and computer generate sounds, and visual media, such as photographs, pre-recorded videos, live video cam images and videos, pre-generated static images, computer generated imagery generated in substantially real time, and defined sequences of one or more of the foregoing. A visualization may be selected or generated based on a user-selected category and/or pre-existing information, such as demographic and/or preference information previously provided by a user, and/or on dynamic factors, such as real-time environmental factors, such as discussed elsewhere herein. As will be discussed herein, various visualizations may be organized as channels for which the user can select. A given channel may include previously defined sequences of visual media and associated audio media and/or dynamically generated visualizations. Images may be sequenced and synchronized with audio media so as to tell a story (e.g., visually and musically introduce characters, depict character interactions with each other and their environment, provide a conclusion, etc.). Controls may be provided via which a user can play, pause, fast forward, reverse, or play in slow motion the visualization.

Certain embodiments may provide one or more channels of visualizations, which synchronize visual and audio media. For example, a given channel may synchronize music or other audio media with one or more of the following:

real time computer generated imagery, generated at least partly in response to characteristics of currently playing music (e.g., the music volume, tempo (e.g., in the frequency domain), beat onset, and/or energy);

dynamically generated sequences of pre-existing static images (e.g., photographs, drawings, etc.) and/or video images provided by an end user of the visualizer;

pre-existing and pre-defined sequences of static images (e.g., photographs, drawings, etc.) and/or video images provided by an end user of the visualizer;

pre-existing and pre-defined sequences static images (e.g., photographs, drawings, etc.) and/or video images provided by the provider of the visualizer (e.g., stored locally to the visualizer in a library setup by the visualizer provider, or in a remote library accessed over a network, such as the internet or other data channel);

dynamically generated sequences of static images (e.g., photographs, drawings, etc.) and/or video images provided by the provider of the visualizer (e.g., stored locally to the visualizer in a library setup by the visualizer provider, or in a remote library accessed over a network, such as the internet or other data channel);

pre-existing and pre-defined sequences of static images (e.g., photographs, drawings, etc.) and/or video images provided by an online social network of the end user;

dynamically generated sequences of pre-existing static images (e.g., photographs, drawings, etc.) and/or video images provided by an online social network of the end user;

pre-existing and pre-defined sequences of pre-existing static images (e.g., photographs, drawings, etc.) and/or video images provided by a third party;

dynamically generated sequences of pre-existing static images (e.g., photographs, drawings, etc.) and/or video images provided by a third party;

substantially real-time live static images (e.g., photographs) and/or video images, such as from a camera placed at a public or private location.

Visual media may be stored locally on a user device (e.g., a mobile device (e.g., mobile phone, a tablet computer, a smart watch, a laptop computer, etc.), a desktop computer, a game console, a television set top box, a smart television, a streaming media appliance, etc.) and/or may be stored remotely and accessed by a user device over a network. For example, the visual media may be stored on a third party video/image sharing site system, a social networking site system, a system associated with the provider of the visualizer, a storage device included in a local network of the user (e.g., accessible over a local Wi-Fi network), other media library, or elsewhere. Optionally, the visual media and/or the audio media may be streamed to a user device via a network interface. The user device may be equipped with a network interface for accessing the visual media and/or the audio media, and a display and a speaker for playing the visual and audio visualization media. Optionally, the user device may be networked to one or more other user devices with displays and speakers.

For certain visualizer channels, a visualizer system may provide an interface via which the user can select one or more media sources for the channel. The visualization system may communicate with user devices with visualizer modules installed thereon and/or remote system(s) having visualizer modules installed thereon. The user may register one or more user devices with the visualization that are to play visualizations and/or that are to be used in the visualization process. A user interface may be provided via which the user may assign names to user devices (e.g., Joseph television, Jacob's tablet, Anna's phone, Eli's game console, etc.) and the assignment may be recorded by the system for later reference by the user.

In addition to being responsive to audio media characteristics, certain embodiments of the visualizer system cause the visual media to be responsive to other inputs. For example, the visual media and/or audio media selection, visual tempo, colors, shapes, and/or patterns may be altered based on stimuli in the user's immediate environment or other specified environment. By way of example, the stimuli may be the detection of who is in the vicinity (e.g., in the room) of the visualizer display, how are people and/or pets moving in the vicinity of the visualizer display, the size of a room where the visualizer display is positioned, the objects in the room where the visualizer display is positioned, the strength of the ambient room light (e.g., dark, dimmed lights, bright lights), the room temperature, the outdoor temperature and/or weather conditions (e.g., sunny, cloudy, rainy, snowy, thunderstorms, etc.) in the geographic area of the visualizer display (e.g., within three hundred feet, one mile or ten miles of the visualizer display, etc.), the outdoor temperature in a geographic area remote from the visualizer (e.g., tens, hundreds, or thousands of miles away), the color of the room walls, the color of clothing worn by a user, a determination as to the current activities of one or more selected users (e.g., are they reading, talking on a phone, talking with another person in the room, etc.), the user's touching of a touch sensor, the presence of sound (e.g., other than sound presented with the visualization), speech recognition, the dimensions and orientation of the display used to display the visualization, etc.

The stimuli may be detected using one or more sensors (which in some cases may optionally be collocated with a user device configured to play visualizations), such as image sensors, heat mapping sensors (which may provide a heat map of a room or a specific user), microphones, touch sensors (e.g., touch sensitive displays on a computing device), temperature sensors, light detection sensors, local area network sensors (that can detect the presence of a device on a local Wi-Fi network), indoor positioning sensors devices (e.g., Bluetooth low energy proximity sensing devices that transmit a unique identifier to the visualizer system), etc. The various sensors may be used to perform facial recognition to identify who is in sensor view, determine what is in the sensor room (e.g., furniture, animals, wall hung art, such as posters, paintings or photographs, etc.), perform skeletal mapping to determine a user's movements and orientation, identify the proximate location of a user, detect ambient sound, perform speech recognition, detect ambient light, measure temperature, measure humidity, etc. The sensors may be operated by a third party entity that streams the sensor information or otherwise provides access to the sensor information to the visualizer system (e.g., over a network, such as the Internet). The sensors may be provided by one or more of user or non-user game consoles, mobile devices (e.g., mobile phones or tablet computers equipped with cameras, microphones, Wi-Fi circuits, Bluetooth circuits, NFC circuits, touch screens, touch pads, mice, other pointing mechanisms, etc.), televisions, desktop computers, standalone cameras (which may also include sound sensitive microphones), thermostats, security monitoring systems, etc.

Optionally, a user interface may be provided via which the user can select what stimuli are to be used in generating visualization. For example, the visualization system may detect what sensors are available to the system (or the user may manually provide such information), and present a list of the sensors from which the use can select to be used to provide stimuli for visualizations. The visualization may also optionally provide a user interface prompting the user to provide information or take certain action via which the visualization can connect to a given sensor. For example, if a sensor and the visualization system have Bluetooth interfaces, the user may be prompted to pair the sensor and visualization system. By way of further example, the user may be prompted to provide a locator, such as a URL, for a sensor feed, optionally including any needed passwords and user identifiers.

Other stimuli may be stimuli manually provided by the user, such as feedback (e.g., in the form of ratings) regarding audio media, visual media, a given visualization presented to the user, or visual media and/or music genre selection. The rating information may be provided by the user, a user-specified set of other users (e.g., other users that the user is socially networked to via a social networking system), and/or the user community at large. By way of example, media that receives poor ratings may be selected less often (or not all if the ratings fall below a specified threshold) in visualizations presented to the user. Similarly, media that receives high ratings may be selected to be used more often in visualizations presented to the user. By way of further example, if the user (or other sets of users as discussed above) consistently (e.g., more than a specified threshold of times, optionally within a specified period of time) provides poor ratings to a given genre of media (e.g., to images of cars or to music with a high beat rate), than that type of media will be used less frequently or not at all in synchronized visualizations presented to the user. Feedback, such as ratings, may be provided in the form of points (e.g., 1-10), stars (e.g., 1-5 stars), descriptive text selections (e.g., “I like this a lot”, “I like this occasionally,” “I dislike this,” “I never want to see or hear this again”, etc.), or otherwise. Optionally, the user may also provide information regarding the user's current mood, which may be used to select audio and/or visual media, and to determine the synchronization characteristics for visualization.

By way of yet further example, when the user registers to use the visualization system (or some time thereafter), the user may be asked via a user interface to respond to various questions which may be used to determine or infer the types of channels and visualizations (visual media and audio media) the user is most likely to prefer. For example, the user may be asked to supply various items demographic information, such as age, physical address or location, or gender. The user may also be asked to provide an address for electronic communications (e.g., an email address, an SMS address, etc.), and indicate what type of electronic communications the user wishes to receive. The user may also be asked to provide a link or access to the user's social network as established on one or more social networking sites in order to enable the visualization system to access information about the media preferences, rankings, and other information of the user's social network. The user may be asked to rate or otherwise provide feedback regarding various items or categories of visual media, audio media, and visualizations. By way of further example, the user may be asked such questions as:

“Would you rather watch a movie, watch sports, be in nature, or read a book?”;

“Which of the following albums would you rather listen to?” (where a listing of albums is presented to the user from which the user can select);

“Which of the following songs do you like?” (where a listing of songs is presented to the user from which the user can select);

“On a road trip which of the following artists would you rather listen to?” (where a listing of artists is presented to the user from which the user can select);

“Which of the following artists would you rather listen to when you are in a good mood?” (where a listing of artists is presented to the user from which the user can select);

“Which of the following artists would you rather listen to when you are sad?” (where a listing of artists is presented to the user from which the user can select);

“Which of the following artists would you rather listen to when you are in a romantic mood?” (where a listing of artists is presented to the user from which the user can select);

“Which of the following artists would you rather listen to when you are in the mood to dance?” (where a listing of artists is presented to the user from which the user can select);

“Which of the following items of video content would you want to watch?” (where a listing of video content, such as movies, television shows, and/or video clips is presented to the user from which the user can select);

“Which of the following photographs would you want to hang on your walls?” (where a listing of photographs is presented to the user from which the user can select).

By way of illustration, if the user indicated that the user would rather read a book than watch a movie, the visualization system may be less likely to select movie clips for inclusion in a visualization or a channel of movie clips for the user. In general, the user's explicit and/or inferred preferences may be used in selecting visual and audio media, and determining or selecting the sequencing thereof, is providing a visualization to the user.

As noted above, a user selection of a genre, such as a music genre (e.g., classical music, opera music, pop music, country music, new age music, relaxing music, dance music, rock music, rap music, singer/song writer music, etc.) may affect the visualization provided by the visualization system. For example, if a user selects “classical music” as a genre then the visualization system may select a classical music recording to be used with the visualization and may select or generate a visualization that correlates to the selected genre of music. For example, if a user selects classical music, the visualization system may select visual media that includes soothing, softly lit images of nature, with a relatively relaxed or slow paced number of transitions.

Certain sub-genres of a given musical genre may be deemed to be more consistent or representative of what the general population thinks of when they think of the musical genre. Thus, for example, if a user selects the genre of classical music, specific types or sub-genres of classical music recordings that are deemed to be more consistent or representative of what the general population thinks of as classical music will be selected for a visualization, while less representative recordings of classical music are not selected. For example, classical music is sometimes sub-categorized as medieval, renaissance, baroque, romantic, minimalism, avant-garde, modern composition, atonal, etc. However, if a determination is made that most people that select classical music as a genre do not want to listen to minimalism or atonal classical music, than those sub-genres of classical music may be excluded for use with the visualization. Of course, if the user is offered a choice of selecting sub-genres of classical music, and the user selects minimalism or atonal classical music, than those sub-genres of music may be used with the visualization.

Thus, optionally a user interface may also be provided via which the user can select genres, including sub-genres of audio media. The genres may be presented in hierarchical manner, where the user may select from a list of high level genres, and for a given selection, sub-genres may optionally be presented. Similarly, if the user selects a particular sub-genre, optionally sub-sub-genres are presented, and so on. The user may decide how many levels down in a genre are to be navigated to and selected from.

Optionally, in addition to or instead of the user selecting genres or sub-genres of music, the visualization system may analyze the type of music the user listens to and/or has stored in the user's media library to determine the user's genre and sub-genre preferences, and may then find corresponding music and/or visual media to use with the visualization. By way of illustration, if a user listens to dance music, the visualization system may select dance music for the audio media and may select images or videos of people dancing for the visual media, and may cause the images to be sequenced at a relative high transition rate.

In order to determine a user's preferences, certain embodiment of the visualization system may access and examine information regarding the user's music library (e.g., titles, artist, performer, tags, song length, album name, etc.) such as may be stored in association with the respective music files in the user's music library. For example, a given item of music's audio structure may be analyzed to determine the music's genre (where the genre determination may be a sub-genre determination). By way of further example, the visualization system may, via a software application installed on a user device, monitor the music the user is playing and determine the type/genre of music the user likes by one or more of the following:

feature extraction;

timbral/texture analysis;

beat structure analysis;

vector/statistical analysis; or

melodic patterns, pitch and/or rhythm clustering.

By way of further example, the visualization system may enable a user to manually specify types and genres of visual media to be used in visualizations. By way of illustration, a menu of visual media types may be presented to the user via which the use may select media types that are to be used in visualizations presented to the user and/or select media types that are not to be used in visualizations presented to the user. By way of example, the media types may include one or more of the following types and/or other media types:

photographs;

pre-recorded videos;

live video cam photographs;

live cam videos;

pre-generated static non-photographic images (e.g., paintings, drawings, etc.);

sequenced images (e.g., still image, video images) that tell a story; text; or

dynamically generated computer generated imagery.

A user interface may also be provided via which the user can select genres of visual media. The genres may be presented in hierarchical manner, where the user may select from a list of high level genres, and for a given selection, sub-genres may optionally be presented. Similarly, if the user selects a particular sub-genre, optionally sub-sub-genres are presented, and so on. The user may decide how many levels down in a genre are to be navigated to and selected from.

For example, the visual media genres may include nature and subsets of nature, activities and subsets of activities, animals and subsets of animals, professions and subsets of professions, people and subsets of people, cities and subsets of cities, entertainment and subsets of entertainment, objects and subsets of objects, and the like. By way of illustration, an example user interface may enable the user to select the genre “nature,” and nature sub-genres, such as “mountains,” “forests,” “oceans,” “deserts,” “national parks,” “snow,” “rain,” “thunderstorms,” “astronomy,” “space,” “the universe,” etc. By way of further illustration, the user interface may enable the user to select the genre “animals,” and animal sub-genres, such as “pets”, “dogs,” “cats,” “birds,” “wildlife,” “insects,” “sea life”, “whales,” “porpoises,” “fish,” etc. By way of yet further illustration, the user interface may enable the user to select the genre “activities” and the sub-genres (or sub-sub genres) of “activities”, such as “sports”, “extreme sports”, “dancing”, “football,” “basketball,” “hockey,” “tennis,” “sailing,” “running,” “hiking,” “ballroom dancing,” “hip hop dancing,” etc. By way of further illustration, the user interface may enable the user to select the genre “entertainment” and the sub-genres (or sub-sub genres) of “entertainment,” such as “television shows,” “movies,” “theater,” “concerts,” “dance,” etc. A given sub-genre may be listed under multiple genres. For example, “dance” may be listed as a sub-genre of both activities and entertainment.

In addition, a user interface may optionally be provided via which a user can specify a mood to be used to select audio and/or visual media, such as for visualization that is about to be played to the user. For example, the user interface may enable the user to specify one or more of the following moods: relaxing, chill, peaceful, happy, sunny, energetic, romantic, wild, broken hearted, light, angry, falling in love, bad day at work, party, vacation, going to sleep, etc. Optionally, the visualization system may infer a user's mood from sensor data. For example, the sensor data may be used to determine if the user is going to sleep, is reading a book, is exercising or dancing, is staring out a window, etc., and respectively infer that the user is in an extremely relaxed mood, a fairly relaxed mood, an energetic mood, a contemplative mood, etc., and may select and/or generate a visualization based at least in part on the user's inferred mood.

In addition, a user interface may optionally be provided via which a user can specify certain other characteristics of the visualization, such as speed, number of transitions in a specified period of time (e.g., no more than 4 transitions/per minute), color (e.g., the visualization should include or emphasize or exclude or deemphasize one or more specified colors), and compositional elements, such as color maps, wave shapes, particles, frame rates, overlays, auras, sprites, delta fields, etc.

In selecting, assembling, and/or generating the visual media to be presented in a visualization, the visualization system may match the visual media to the audio media based on one or more of feature extraction, timbral/texture analysis, beat structure analysis, vector/statistical analysis, melodic patterns, pitch, and/or rhythm clustering with respect to the audio media, in addition to some or all of the stimuli and user preferences discussed herein. For example, the foregoing may be used to select or set:

a) pre-set sequenced images based on selected audio and/or visual genre (including sub-genre) classifications;

b) user-defined image genres or categories (e.g., nature, space, sports, pets, etc.) sequenced to selected audio and/or visual genre (including sub-genre) classifications.

c) the sequencing of visual elements utilizes components such as mood (story), transitions, speed, color and composition in its correlation to the genre.

Some or all of the data received from users, including user-related data discussed herein (e.g., rankings, preferences, genre selections, visualizations viewed, visualizations shared, when visualization were viewed, on how many user devices were visualizations displayed, etc.), may be shared via reports or direct data access with others, such as content producers (e.g., record companies, movie studios, television studios) and advertisers.

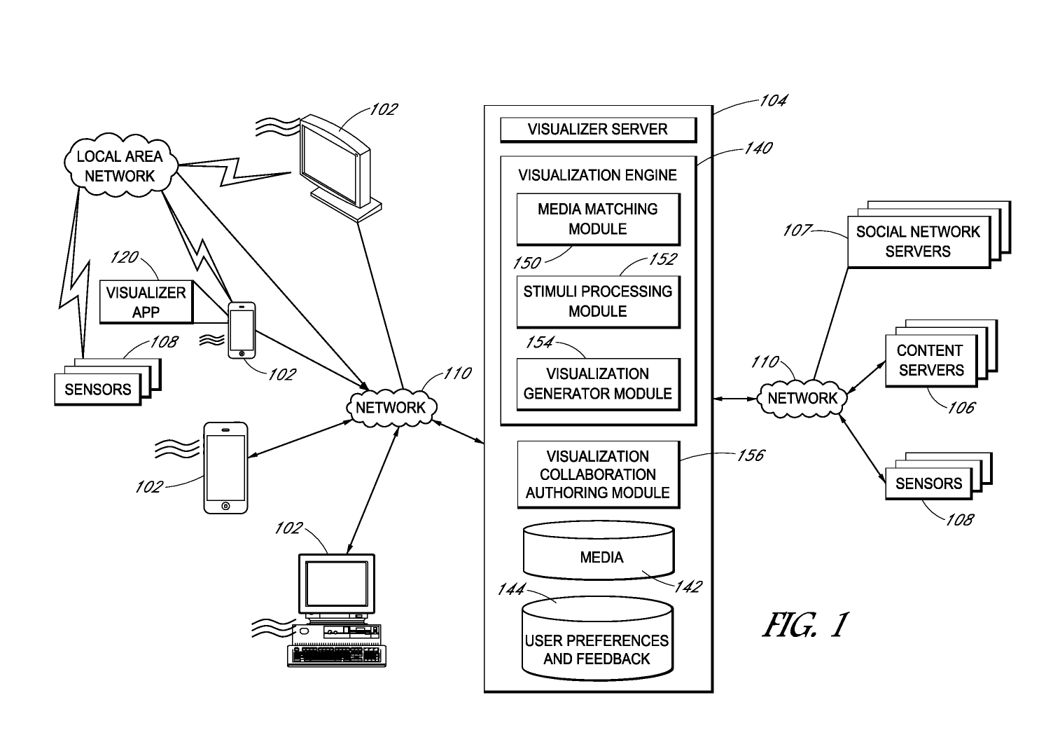

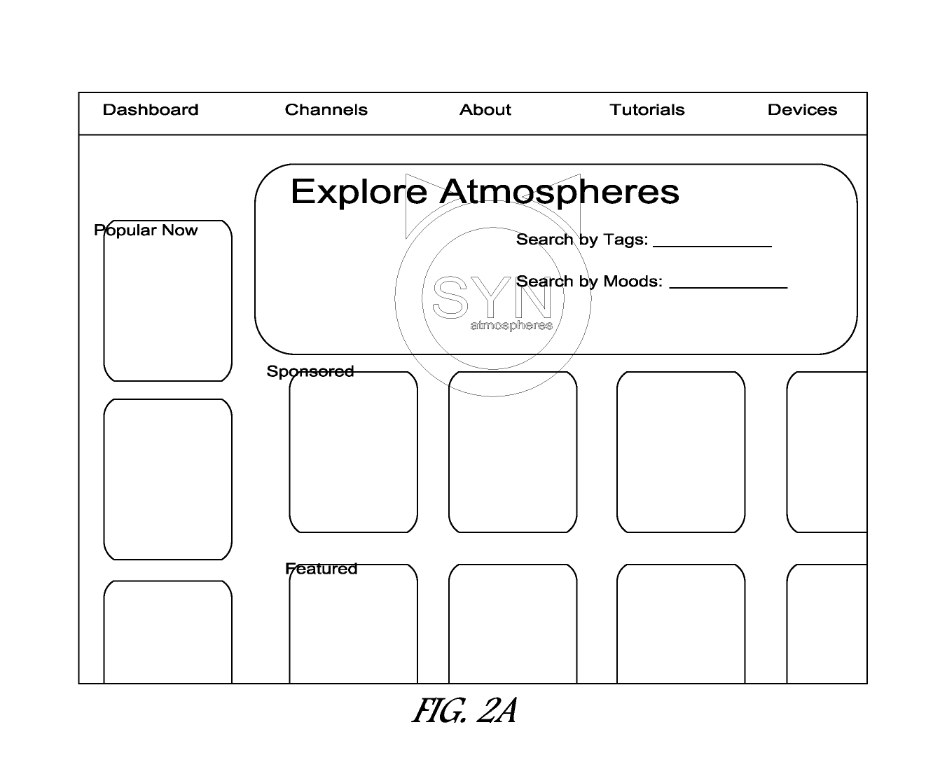

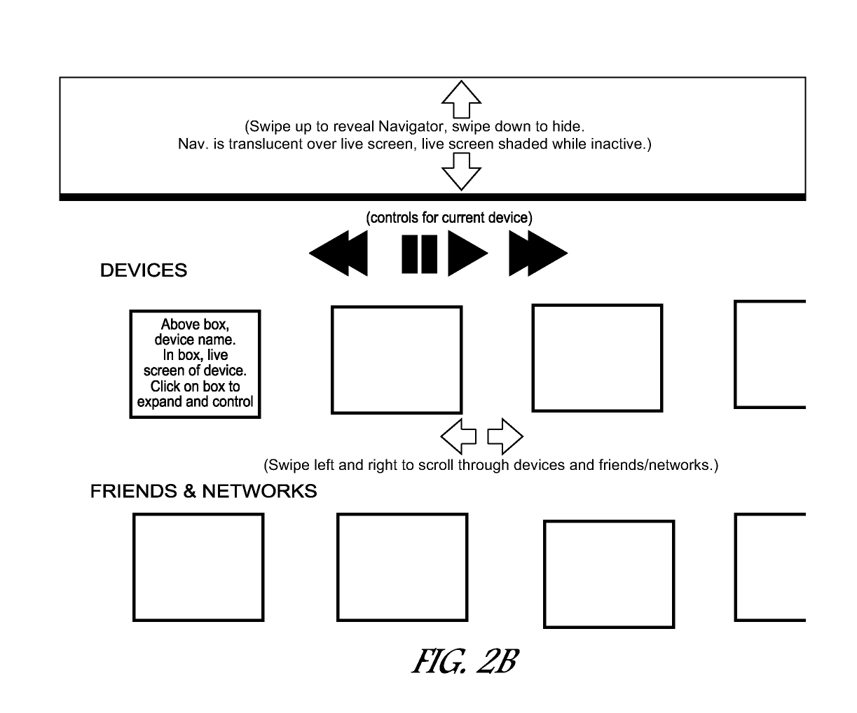

Certain examples will now be discussed with reference to the figures. Referring now to FIG. 1, and example architecture is illustrated which may be used in an embodiment. A visualization system may include one or more visualization servers 140 (e.g., optionally using a cloud-based architecture, wherein the servers 140 form the backend, to provide visualization services on a software-as-a-service (SaaS) basis; optionally using an enterprise or local architecture) hosting a media selection and matching module 150, a stimuli processing module 152, a visualization generator module 154, a media data store 142, and a user account, preferences, and feedback data store 144. The visualizer server 104 may communicate over a network 110 with one or more audio and visual content servers 106, one or more sensors 108 (which may be local to a user or remote from a user), and one or more social network servers 107. By way of example, the audio and visual content servers 106 may be associated with a music, movie and/or television content provider, a publicly accessible video sharing site, or other source. Optionally, as compensation to the content provider, a content provider logo or other advertisement may be displayed to the user via the visual media included in the visualization.

The visualization system may include a visualization collaboration authoring module 156, which provides audio and visual tools to help facilitate collaboration between audio and visual artists to create visualizations. The tools may enable a user to specify a source for audio media and visual media, to edit the audio media (e.g., by changing the tempo, changing the beats per minute, warping audio tracks to match the beat, adjusting the phase of the beats, mixing songs together, edit the track amplitudes at selected points, equalizing the tracks, to perform sound wave mapping (where a visual sound wave of an audio track is presented, enabling the user to manipulate the audio via the sound wave so as to match or synchronize the audio track with the visual media, such as matching frames of the visual media with transitions of the audio media or vice versa, etc.), and/or to edit the visual media (by cropping images, deleting or duplicating frames, mixing frames, changing frame rates, changing the image colors, tints, sharpness, synchronizing visual media with audio media, etc.). The collaboration tools enable multiple users to collaborate over a network to develop the visual and audio aspects of visualization. Optionally, the collaboration tools enable collaborators to access and edit shared media files across a network, optionally without copying the files or by using relatively low resolution proxy files, where the final edits are applied to relatively high resolution versions of the media. Thus, the visualization collaboration authoring module enables those with even relatively low expertise in creating visualizations to create visualizations.

As similarly discussed elsewhere herein, the visualization server 104 may access audio and/or visual media from the media data store 142 and/or the content servers 106. The visualization server 104 may access sensor readings from the sensors 108. By way of example, the sensors 108 may include one or more of video sensors, image sensors, sound sensors, temperature sensors, light sensors, image recognition sensors, heat map sensors, skeletal mapping sensors, weather data feeds, and/or other sensors. The visualization server 104 may access social network information for a given user from a corresponding social network server 107. One or more of the sensors 108 may optionally be included in one or more user devices 102 (e.g., a television, a mobile phone, a tablet computer, a desktop computer, a laptop computer, a home thermostat, a home security system, etc.).

The sensor data may be processed by a stimuli processing module 152 for use by the media matching module 150 and/or the visualization generator module 154. For example, the stimuli processing module 152 may normalize and weight sensor data. By way of illustration, the stimuli processing module 152 may scale a temperature reading to fall within a range of 1-10 (e.g., where 0 degrees or less with be assigned a “1,” and 100 degrees or higher will be assigned a “10,” and various temperature ranges between 0-100 degrees will be assigned a corresponding number). The sensor data weights may be selected to as to enable certain sensor data to have more of an impact on a visualization than other sensor data. For example, temperature sensor data may be weighted more heavily than humidity sensor data, and so would have a greater impact on the generation and/or selection of a visualization.

As discussed elsewhere herein, the visualizer system may utilize a user channel selection, information from the user account, preferences, and feedback data store 144, and/or from the sensors 108 to generate or select a visualization. For example, the media matching module 150 may select visual media, audio media, or predefined sequences or visualizations based on such inputs, and may further determine the story, speed, transitions, color, and/or composition accordingly. The visualization generator module 154 may then generate a given visualization based on data from the media matching module 150, and provide the visualization to one or more user devices 102 for display to the user.

The visualization may be streamed by the visualization system to a user device 102, provided as a pre-rendered file to the user device 102, or may be in the form of instructions transmitted to the user device 102 where visual and audio media is accessed by the user device locally or from another remote system. For example, the instructions from the visualization generator module 154 may provide locators for the visual and/or audio media (e.g., in the form of file paths and names, URLs, or otherwise) and may provide sequencing, transitioning, and/or composition instructions. A visualization application 120 hosted on the user device 102 may then execute the instructions to access, assemble, sequence, transition, and compose media to render the visualization via a user device display and speakers (which may be the display and speakers of the user device executing the instructions or may be a different user display and speakers in communication via a local or other network with the user device executing the instructions). Optionally, instead of or in addition to using a visualization app to render a visualization, a visualization may be rendered or presented by a general purpose web browser. Optionally, all or certain components of the visualizer server 104 may be included in one or more of the user devices 102.

By way of illustration, if the visualizer system detects and identifies, via one or more sensors, a specific user has entered a room where a registered user device is, the visualizer system may cause a visualization to be displayed on the user device, where the visualization is based on that specific user's preferences and characteristics. By way of further example, if the visualization system determines from sensor information that two people are sitting in touching proximity on a couch, the visualizations system may provide a romantic visualization (e.g., using romantic music and romantic images, such as that of sunsets or two people boating). By way of additional example, if the visualization system determines a user is consuming some other media, such an electronic book on an electronic device (e.g., a tablet computer), the visualization may select and provide a visualization that would go well with the other media being consumed, or in particular, with what is occurring in the other media being consumed. By way of illustration, the visualization presented by the system may be different if the user is reading a romantic portion of a book than if the user is reading a violent passage of the book. The visualization system may determine the content of the electronic book (and the portion of the book currently being presented to the user) via information provided by the electronic device over a network or otherwise. By yet further example, if the visualization system determines from sensor information that a user is sitting on a couch and reading a book, the visualizations system may provide a mellow visualization (e.g., using soothing music of a genre that the user prefers and images of a genre the user prefers). By way of further example, if the visualization system determines from sensor information that the outside local temperature is below 40 degrees, the visualization system may provide a visualization with warm colors or images (e.g., images of a fireplace, of a brightly lit landscape, etc.). By yet further example, the visualization may be selected based at least in part on a determined age (or age range) and/or gender of one or more persons. For example, if it is determined that young children are in the room, than child-friendly images and audio may be selected (e.g., images of toys, animated characters, nursery rhyme images, etc.).{

Optionally, if the system determines from sensor data that two or more users are in a room with a visualizer display, and each user has submitted preference information, the system may select or generate visualizer media based on the preferences of the multiple users that will be please each of the users even if the selected or generated visualizer media is not the most preferred of any of the users.

Optionally, a user may be able to share the user's preferred channels and/or visualizations with other users, such as other specified individual users and/or other users in a social network of the user (e.g., as determined from social networking information from one or more social networking sites), or other users without limitation. The user may specify how and with whom the user's preferred atmospheres, channels and/or visualizations are to be shared and the specification may be stored by the visualization system and/or by a user device. For example, a user may identify a given channel and/or visualization as preferred, which will then be shared by the visualization system with other users in accordance with the user's specifications. Optionally, a user may specify that all channels and/or visualizations played on a user device are to be shared with other users. The system may share such channels and/or visualizations by transmitting a communication providing the visualization names and links to the channels and/or visualizations. The communication may be in the form of an email, an SMS or other short message, a Web page, a phone app notification, via a social networking site of which the user is a member or otherwise.

Optionally, a given visualization may be provided to more than one device of a user (e.g., based on a user instruction), so that the visualization may be displayed/played on multiple user devices 102 at the same time. For example, a user may specify via a user interface that all or specific visualizations are to be displayed/played on a kitchen television, a den television, and a master bedroom television at the same, so that as the user wanders through the user's house the user may continuously experience the same visualization. Optionally, the user interface may enable the user to specify that different visualizations or channels of visualizations are to be displayed on different specified devices. For example, the user may specify that a relaxing visualization channel is to be displayed on a bedroom display device and that a dance channel is to be displayed in a den display device. The user may provide a map of the area(s) where the user device are located and indicate where the user devices are located (e.g., on which wall of which room). The user's specification may be stored by the visualization system and/or a user device, which will cause visualizations to be displayed on user devices accordingly. Optionally, the number and/or placement of the user devices may be used by the visualization system in selecting, generating, or modifying visualizations. By way of illustration, if two user devices are side-by-side, the visualization may cause a first portion of a visualization scene/image to appear on a first of the user devices, and a second portion of the same visualization scene/image to appear on a second of the user devices in a coordinated fashion (e.g., if the visualization includes a scene of a forest, a first portion of the forest may be displayed on the first user device and a second portion of the forest may be displayed on the second user device). By way of further example, if a first user device is placed on a first wall of a room and a second user device is placed on a second, opposite wall of the room, the visualization system may coordinate the visualization so that images from a front facing camera (an actual camera, or a virtual camera if the images are computer generated) are displayed on the first user device, and images from a rear facing camera are displayed on the second user device. Thus, the visualization system can use multiple user device to provide a visualization that surrounds the user.

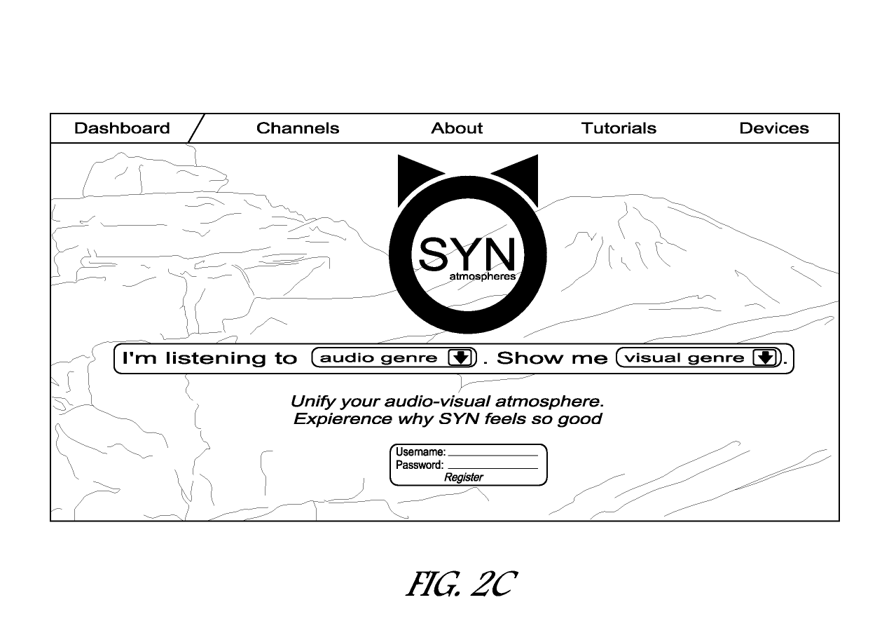

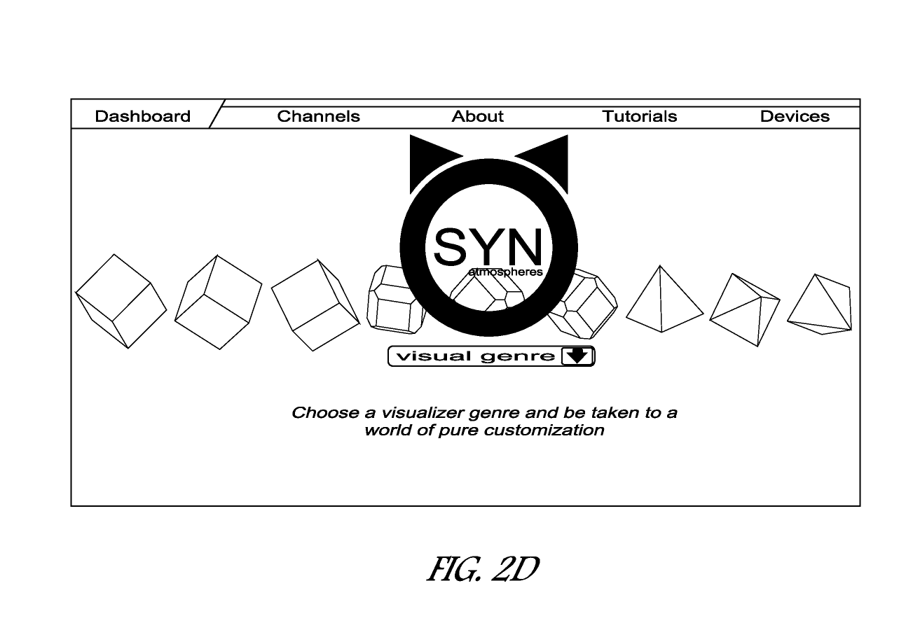

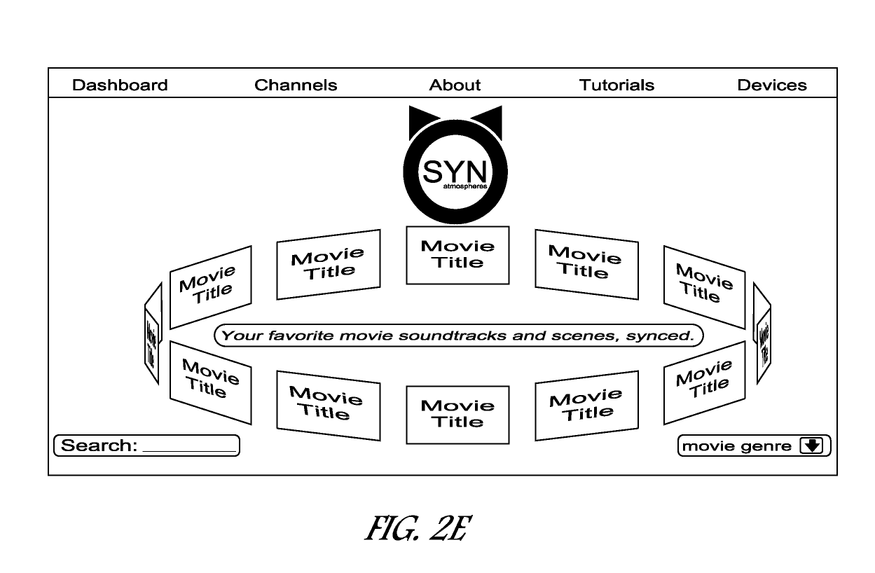

Certain example user interface will now be described with reference to the figures. The various interfaces may be provided via a dedicated application, via a web page, or otherwise. FIG. 2A illustrates an example dashboard. The dashboard provides access to a default set of visualization channels (e.g., via radio buttons, links, or otherwise that provide a channel name and/or channel link) from which the user can select. Optionally, the user can edit the set of channels by adding or deleting channels. The dashboard user interface provides feedback controls via which the user can rate or otherwise provide feedback regarding visualizations. As previously discussed, such feedback may be used by the visualization system to further customize the channels and/or visualizations.

In addition, the example dashboard interface enables the user to specify which visualizations may be shared with which other users. The dashboard may also enable the user to update the user's genre and other preference information. The dashboard may include links to one or more social networking platforms via which a user can register to use the visualization system services and via which the user can share visualizations and channel preferences, as well as ratings. The dashboard may selectively offer features to certain users, such as new users. For example, the dashboard may provide an introduction to the user of the visualization system, preference questions, questions regarding what the user is looking for out of the experience with the visualizer system, and/or what features are important to the user. In addition, the dashboard user interface may enable the user to explore channels and may include some or all of the functionality as the navigation controls discussed herein.

Optionally, this and/or other user interfaces may have visual media from one or more visualizations playing in the background and may optionally play corresponding audio media. The visualization system may optionally select the visual media for the background from a visualization that the user had previously provided a high rating for, or the visualization system may optionally select visual media from a visualization the system estimates that that the user will like based on previous user feedback regarding other visualizations and/or based on user preference information. Thus, the background visual media presentations may enable the user to discover new visualizations that the user has not previously viewed. The user interfaces optionally provide feedback controls via which the user can provide feedback regarding the background visual media. The feedback may be used by the visualization system to further customize channels and visualizations for the user.

In addition, the dashboard and/or other user interfaces may prompt the user to log in to their account and to register with the visualization system if the user has not already registered. The dashboard and/or other user interfaces may include search fields and controls via which a user can search for channels, visualizations, genres, audio media, visual media, other users and the like. Optionally, the user can provide filters that may further specify the search object (e.g., limit search to only channels, only visualizations, only genres, only audio media, only visual media, etc.). The visualization system may search for matches using a search engine and provide the user with some or all of the matches, optionally ranked so that the closer matches are presented at the top of the search results, and the more distant matches are presented further down.

FIG. 2B illustrates an example navigation user interface. The navigation user interface may optionally be accessed directly from some or all of the user interfaces disclosed herein. (e.g., by swiping a touch screen, selecting a navigation control, etc.). The navigator may list visualization channels chosen by the system and/or by the user. Via the navigator, family or friend groups may create device networks to share and control the visualizations and stations created by or experienced by a given user within the group. Further, the navigation user interface enables a user to navigate between networked user devices and to control which channel is to be played on which user device. Icons or other identifiers (e.g., device names previously assigned by the user) corresponding to the user's networked devices may be displayed. For example, the user may specify that different channels are to be displayed on different sets of devices, or that all user devices are to play the same channel. In addition, the user may add, delete, or change the ordering of visualization channels presented via the navigation user interface.

Certain example channel user interfaces will now be described. The channel user interfaces may be presented in response to a user selecting a corresponding channel entry in the dashboard, via a menu of channels accessed from a given channel user interface, or otherwise. A given channel user interface may enable the user to select which sensors are to be used to customizing a channel, specify to which device(s) a given channel is to be streamed or otherwise displayed, and provide an interface via which the user can provide channel/visualization feedback (e.g., in the form of ratings), share customized channels and visualizations, share news and comments, etc.

Referring now to FIG. 2C, an example user interface is illustrated for a channel having the following characteristics:

uses a matching algorithm to correlate audio and visual elements into a sequenced visualization, optionally using user ratings and sensor data;

uses genre classification in generating a sequenced visualization. For example, the genre may be explicitly selected by the user via a menu of audio media and/or audio media genres (e.g., presented via a drop down box displayed in response to a user action, such as may be accessed via the example illustrated “I'm listening to” visual genre menu) or the genre may be selected based on a detected genre for a given item of audio media (e.g., an item of audio media currently being played by the user) using genre detection techniques, such as:

feature extraction;

timbral/texture analysis;

beat structure analysis;

vector/statistical analysis; or

melodic patterns, pitch and/or rhythm clustering.

The user may manually select a genre or category of visual media for the visualization via a menu of visual media and/or visual media genres (e.g., presented via a drop down box, such as may be accessed via the example illustrated “show me” visual genre menu, displayed in response to a user action), or the user may specify that the selection should automatically perform the selection. The visualization system may perform image matching for the channel, where the visual media is selected or generated to correlate to one or more of:

pre-set sequenced images (where the sequencing is selected by a computer-based or human curator) based on selected audio and/or visual genre (including sub-genre) classifications;

user-defined image genres or categories (e.g., nature, space, sports, pets, etc.) sequenced to selected audio and/or visual genre (including sub-genre) classifications.

the sequencing of visual elements utilizes components such as mood (story), transitions, speed, color and composition in its correlation to the genre.

Optionally, the user may be provided with controls to enable the user to play, pause, fast forward, reverse, or play in slow motion the visualization.

FIG. 2D illustrates an example user interface for another example channel. The illustrated channel provides computer generated abstract visualizations and optionally integrates substantially real time user input (e.g., provided by touch screen input, mouse input, keyboard input, optical sensor (e.g., visible light or infrared camera), sound sensor, etc.) to customize the visualization experience. The channel user interface illustrated in FIG. 2D may present a menu of visualization types from which the user can select (e.g., waves, particle bursts, fountains of particles, geometric figures in motion, computer generated stars and planets, fractals, etc.).

For example, the visualization system may customize the user experience based on data from touch sensors, sound sensors, speech recognition sensors, or optical sensors to customize visualizations. By way of illustrative example, if the system determines from the sensor data that the user is singing along with the visualization, the visualization system may attempt to synchronize the visual and/or audio media of the visualization with the user's signing (e.g., by performing beat matching), by altering the pitch of the audio media, by playing back the user's voice as part of the audio media with the voice processed to bend the voice pitch, etc. By way of further example, the system may modify the colors, shapes, and/or motion of items in the visualization based at least in part on the user's voice (e.g., the beat, volume, or notes of the user voice).

By yet further illustrative example, an application, such as visualizer app 120 illustrated in FIG. 1, may be provided on a user's mobile device having a touch sensitive screen. If the user opens the application, the application presents a user interface. The user may touch the screen displaying the user interface using a finger or stylus, and based on the location, velocity, acceleration, and/or directional motion of the user's touch, the visualization system may modify the colors, shapes, and/or motion of items in the visualization. For example, optionally the faster a user moves a finger across the screen the faster the motion will be of objects in the visualization. By yet further example, if the user moves a finger in a certain motion (e.g., a counter clockwise circular motion), the system may cause some or all items in the visualization to move in a corresponding fashion. Optionally, user motions, including that of the user's torso, fingers, limbs, and/or head, may be detected using a motion sensor, such as may be provided by a game console that provides for full body control or otherwise. Thus, for example, if the user is dancing, the visualization may modify the colors, shapes, and/or motion of items in the visualization based at least in part on the user's dance motions and speed. By yet further example, the mobile device application may present a color map via which the user can select a color or color range to be used in the visualization. In addition, the visualization may modify the beat of the audio media in response to a user's interaction with the touch screen or other sensor and correspondingly synchronize the visual media to the modified beat. Further, the mobile device application may enable the user's touch to be converted to visual elements, such as water ripples, snowflakes, bubbles, auras, lighting, selected shapes, etc., which may be displayed in conjunction with or in place of the previously presented visual content. For example, touching a ripple interface presented by the mobile device may cause, via the visualization system, the visual portion of the visualization to ripple in a corresponding fashion. By way of further illustration, touching a shape icon presented by the mobile device may cause the visual portion of the visualization to change to the corresponding shape.

FIG. 2E illustrates an example user interface for still another example channel. The example channel provides visualizations where the soundtrack of a movie or show (or other story-based media having a musical soundtrack and a visual component) is matched up and synchronized with selected scenes from that movie or show, so as to be sequenced to correlate with the mood of the soundtrack and/or to provide an overview or summary of the movie or show (e.g., less than one third or one quarter the length of the corresponding movie or show). For example, the visualization for a 90 minute or longer movie may be less than 10 minutes. The scenes may be selected to be visually and thematically among the more interesting or relevant scenes in the movie or show. The soundtrack may be automatically synchronized with such scenes, or an operator may manually perform some or all the synchronization. The total length of such visualizations may have a specified minimum and/or maximum length (e.g., no less than 2 minutes long and no more than 15 minutes long). Such visualizations may be submitted to the visualization system by the studio or other rights holder of the movie or show. Optionally, the user may be charged an additional fee for viewing certain of such visualizations, although optionally the visualizations may be provided to the user without charge. Optionally, some or all of the user fees for such visualization may be provided to the respective rights holder or some or all of the user fees may be retained by the visualization system operator.

The example user interface illustrated in FIG. 2E includes search fields and controls enabling the user to browser or search for movies by name, genre, actors, composer, musical performer, writer, director, release date, etc. The visualization system may utilize a search engine to locate matching movies or shows and may display the search results, including the matching movies or shows, to the user. The user can then select a given movie or show for playback, to purchase (where controls may be provided via which the user can purchase the movie or can purchase just the soundtrack), to provide feedback on, to share a link to, or to share a recommendation regarding (e.g., via social networking systems). Purchased movies or shows may be provided to the user by the visualization system or other system or entity in the form of a download file, in streaming form, or via physical media (e.g., an optical disk or solid state media). Additional exclusive content may be made available to user when purchasing media based on distribution/content agreements with content providers. For example, if a user purchases an online movie, related visualization media (e.g., selected portions of the online movie) may be provided as well for use by the visualization system.

The user interface illustrated in FIG. 2E may also display on the channel home page featured visualizations, such as of new and/or very popular movie or show releases, for which a rights holder paid for home page placement to promote such movie or show.

FIG. 2F illustrates an example user interface for still another channel. The example channel provides visualizations submitted by visualization authors, such as musical artists, visual artists (e.g., videographers, cinematographers, photographers, graphic artists, illustrators, designers, directors, etc.), and the like. A given visualization may be the result of a collaboration between two or more authors and may be configured to provide a certain atmosphere. Optionally, the selection of author-submitted visualizations is curated so that only those deemed of sufficiently high quality or of sufficient interest are provided via the channel. The user interface may provide links to popular visualizations and visualizations that match the user's profile (e.g., the user's preferences and/or demographics). A randomizer control may be provided, which when activated by the user, causes random author-submitted visualizations to be presented to the user.

The user interface illustrated in FIG. 2F may also include a search field via which the user can search by keyword, composer, musical performer, artists, etc. The visualization system may utilize a search engine to locate matching visualizations and may display the search results, including the matching visualizations, to the user. The user can then select a given matching visualization for playback, to purchase if for sale (where controls may be provided via which the user can purchase the visualization including both the visual and audio components, or can purchase just the soundtrack), to provide feedback on, to share a link to, or to share a recommendation regarding (e.g., via social networking systems). Optionally, an author may specify if the author's visualization is to be streamed or downloaded to users for free or for a fee. The fees may be shared by the authors and the visualization system operator. Optionally, an author may specify that a preview of a portion of the visualization may be provided for free, but that users are to be charged for viewing the entire visualization.

In addition, the user interface illustrated in FIG. 2F may include a collaboration interface via which an author can search for one or more other authors to collaborate with. For example, a video or computer media artist may search for a musician to collaborate with or a musician may search for a video or computer media artist to collaborate with. Users may register with the visualization system and describe (e.g., via free text, key words, or menu selections) their area of skill (e.g., musician, videographer, animator, painter, graphic artists, etc.), their style (e.g., modern, minimalist, traditional, documentary, music video, comedic, romantic, story-telling, etc.), and their collaboration interests (e.g., whether or not they are interested in collaboration queries, what types of projects they are interested in collaborating in (e.g., a movie, music video, story, abstract visualizations, album art, graphics), etc.). The system may store such information in the user's account/profile record. A user may search for collaborator via a search query (e.g., specify keywords, professions, skills, style, etc.) identifying characteristics of a desired collaborator. The visualization system may use a search engine to locate matches among other users that have indicated they are open to collaboration requests. The search engine may present the search results to the user. The user may then view selected profile information for users identified in the search results (e.g., their profession, area of skill, style, collaboration interests, etc.), select one or more of the users, and initiate a query to the users to determine if a given user is interested in collaborating. For example, the query may include the requesting user's profile information, a description of the collaboration project, and the artistic contribution the user is making towards the project and the artistic contributions the user is seeking from others. The query and response may be communicated via the system by email, SMS message, webpage, mobile device application, or otherwise. Users may optionally collaborate using the collaboration tools discussed above with respect to visualization collaboration authoring module 156.

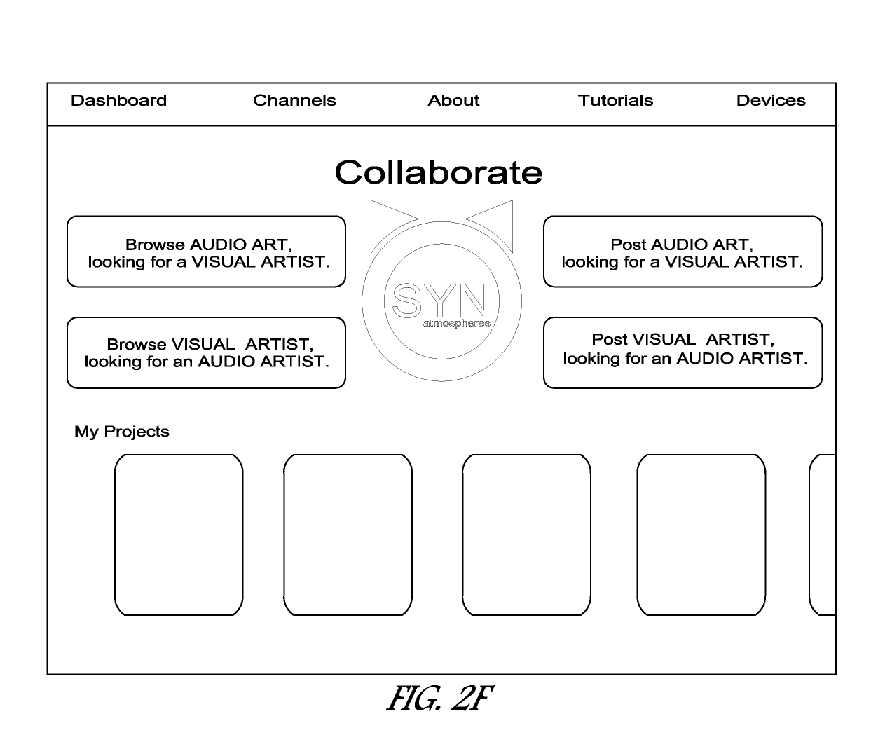

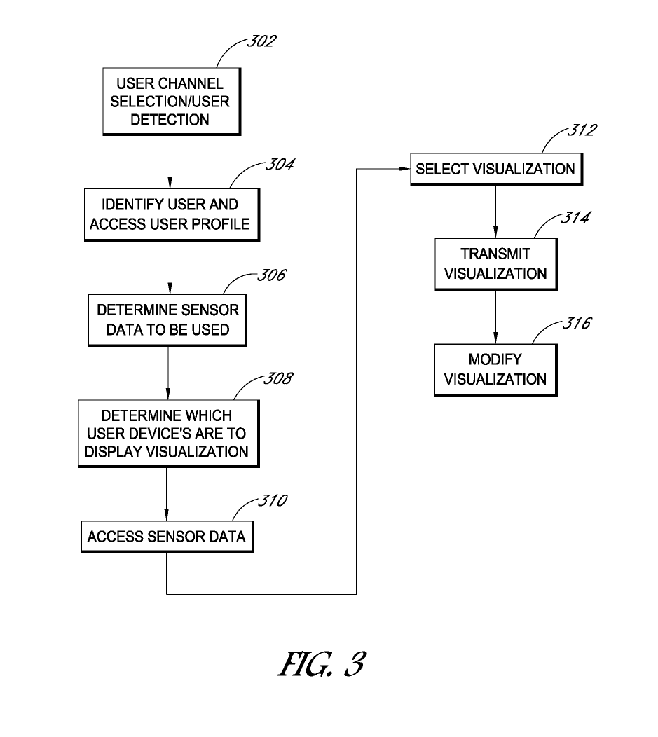

Referring now to FIG. 3, an example process is illustrated. At block 302, a user selects a visualization channel or a user is detected via a sensor. At block 304, the visualization system identifies the user and accesses the user's profile information. At block 306, the visualization system determines from the user profile or otherwise which, if any, sensor data is to be used with respect to selecting, generating, or modifying a visualization. At block 308, a determination is made from the user profile or otherwise as to which user devices the visualization is to be provided to. At block 310, the designated sensor data is accessed over a network or otherwise. At block 312, the system selects a visualization based at least in part on some or all of the following: the user channel selection, some or all of the user profile information (e.g., the user's preferences, the user's demographics, viewing history, ratings from the user or other users), the specified sensor data, and/or other criteria and stimuli. At block 314, the visualization system transmits the visualization (either pre-rendered or on the form of instructions) to the designated user device(s), which may then display the visualization. At block 316, the visualization is dynamically modified based on the designated sensor data.

Thus, disclosed herein are various embodiments of methods and systems for visualizations that provide an engaging and interactive experience.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc.

The results of the disclosed methods may be stored in any type of computer data repository, such as relational databases, non-relational databases, and/or flat file systems that use volatile and/or non-volatile memory (e.g., magnetic disk storage, optical storage, EEPROM and/or solid state RAM). For example, one or more repositories may optionally be configured to support transactions with SQL (Structured Query Language) and/or NoSQL repositories. The NoSQL repository may use a schema-less model, in the form of a document-oriented database that aggregates data into documents, optionally using a JSON format, making it “Big Data” friendly. Optionally, a given repository may include one or more caching tiers to enhance search speed. Optionally, certain applications and services discussed herein may be hosted using cloud-based services, which may be operated by third parties providing cloud-based hosting solutions. Optionally, a multi-tiered architecture may be used, where applications are accessed through an interface, such as web browser or mobile application, connected to a network, such as the Internet. In the cloud, a load balancer may direct incoming traffic to a tier of web and/or application servers that execute applications.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box, select a link, or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone application, computer application, a short messaging service message (e.g., SMS, MMS, etc.), instant messaging, email, push notification, audibly, and/or otherwise.

The user devices described herein may be in the form of a mobile communication device (e.g., a cell phone), laptop, tablet computer, desktop computer, set top box, interactive television, game console, media streaming device, head-wearable display, networked watch, etc. They may optionally include displays, speakers, user input devices (e.g., touchscreen, keyboard, mouse, voice recognition, movement detectors, position detectors, etc.), network interfaces, etc.

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the invention can be practiced in many ways. As is also stated above, the use of particular terminology when describing certain features or aspects of certain embodiments should not be taken to imply that the terminology is being re-defined herein to be restricted to including any specific characteristics of the features or aspects of the invention with which that terminology is associated.

1. A computer-implemented method of providing visualizations, the method comprising:
identifying a first user;
accessing profile information for the identified first user;
determining which user-specified sensor data is to be used in generating or modifying at least one visualization;
providing a first user interface enabling the first user to indicate on which of a set of networked devices the at least one visualization is to be played by, wherein the user can selectively specify that the at least one visualization is to be displayed on a plurality of networked devices or on a single device;
identifying a set of devices that the at least one visualization is to be displayed on based at least in part on a user specification provided via the first user interface;
maintaining a library of sequences of images;
storing genre information in association with respective sequences of images;
detecting music currently being played by at least one device in the set of devices;
accessing genre information and tempo information for the detected music currently being played by at least one device in the set of devices wherein the genre information for the detected music is determined based at least in part on feature extraction performed on the detected music;
accessing genre information for one or more of the sequences of images, wherein a given sequence of images includes images mixed together or images displayed at different rates, or both images mixed together and images displayed at different rates;
based at least in part on:
the genre information and tempo information for the detected music currently being played by at least one device in the set of devices, the first user profile information, and on the accessed genre information associated with the one or more sequences of images,
selecting a first sequence of images for a first visualization to be displayed on the set of user devices as an accompaniment to the music currently being played by the at least one device in the set of devices;
causing the first visualization to be streamed from a server for display on the set of user devices; and
receiving the user-specified sensor data;
enabling the first visualization to be dynamically modified based at least in part on the user-specified sensor data.

2. The method as defined in claim 1, the method further comprising providing an interface via which the user can select a visualization channel from a first set of visualization channels, the first set of visualization channels including at least one visualization channel that comprises computer generated abstract visualizations and at least one channel of movie-based visualizations wherein a given movie-based visualization consists of only a relatively small portion of scenes from a corresponding movie.

3. The method as defined in claim 1, wherein the genre classification of the music is automatically further determined, at least in part, from one or more of:
feature extraction,
timbral texture analysis,
beat structure analysis,
statistical analysis,
melodic pattern clustering,
pitch clustering, or
rhythm clustering.

4. The method as defined in claim 1, wherein the user-specified sensor data comprises optical sensor data.

5. The method as defined in claim 1, wherein the user-specified sensor data comprises skeletal mapping data.

6. The method as defined in claim 1, wherein the user-specified sensor data comprises heat mapping data.

7. The method as defined in claim 1, wherein the user-specified sensor data comprises user motion information.

8. The method as defined in claim 1, wherein dynamically modifying or generating the first visualization further comprises modifying a beat of the first visualization.

9. The method as defined in claim 1, wherein dynamically modifying or generating the first visualization further comprises modifying an audible communication of the first user provided while the first visualization is played and including the modified audible communication in the first visualization.

10. The method as defined in claim 1, the method further comprising determining a physical location of at least a first user device in the set of user devices, wherein dynamically modifying the first visualization is based at least in part on the determined physical location of the first user device.

11. The method as defined in claim 1, the method further comprising enabling the first user to share the first visualization with others via a social networking system.

12. The method as defined in claim 1, wherein the first visualization is selected based in part on feedback provided by other users.

13. The method as defined in claim 1, the method further comprising providing a collaboration system configured to enable two or more users to collaborate on a visualization,
wherein a given collaborating user is enabled to specify a source for audio media and visual media to be used in the visualization, and to edit the audio media to be used in the visualization by:
(a) changing the tempo, or
(b) the beats per minute, or
(c) warping audio tracks, or
(d) adjusting beat phase, or
(e) mixing two or more audio sources, or
(f) editing audio track amplitudes at selected points, or
(g) equalize the tracks, or
(h) performing sound wave mapping, or
(i) and combination of (a), (b), (c), (d), (e), (f), (g), or (h);
and to edit the visual media to be used in the visualization by:
matching visual media frames with transitions of the audio media to be used in the visualization;
matching the audio media to be used in the visual media with the visual media frames;
cropping images,
deleting or duplicating frames,
mixing frames,
changing frame rates,
changing image colors,
changing image tints,
changing image sharpness.

14. A computer-implemented method of providing visualizations, the method comprising:
providing a first user interface enabling a first user to indicate on which of a set of networked devices at least one visualization is to be presented by,
wherein the user can selectively specify that the at least one visualization is to be presented on a plurality of networked devices or on a single device;
identifying a set of devices that the at least one visualization is to be presented on based at least in part on a user specification provided via the first user interface;
maintaining a library of sequences of images;
storing genre information in association with respective sequences of images;
detecting music currently being played by at least one device in the set of devices;
accessing genre information and tempo information for the detected music currently being played by at least one device in the set of devices wherein the genre information for the detected music is determined based at least in part on feature extraction performed on the detected music;
accessing genre information for one or more of the sequences of images, wherein a given sequence of images includes images mixed together or images displayed at different rates, or both images mixed together and images displayed at different rates;
based at least in part on:
the genre information and tempo information for the detected music currently being played by at least one device in the set of devices, and on the accessed genre information associated with the one or more sequences of images,
selecting a first sequence of images for a first visualization to be displayed on the set of user devices as an accompaniment to the music currently being played by the at least one device in the set of devices;
causing the first visualization to be streamed by a visualization server to, and presented on the set of user devices as an accompaniment to the music currently being played by the at least one device in the set of devices, wherein the first visualization correlates with a mood of the music.

15. The method as defined in claim 14, wherein the selection of the first sequence of images for the first visualization is based in part on information accessed from an account record of the user.

16. The method as defined in claim 14, wherein the selection of the first sequence of images for the first visualization is based in part on information accessed from a thermal imaging sensor.

17. The method as defined in claim 14, wherein selection of the first sequence of images for the first visualization is based in part on movements of one or more people detected via a movement sensor at a first location, ambient light at the first location, colors of one or more objects at the first location.

18. The method as defined in 14, the method further comprising providing an interface via which the user can select a visualization channel from a first set of visualization channels, the first set of visualization channels including at least one visualization channel that comprises computer generated abstract visualizations and at least one channel of movie-based visualizations of a first genre wherein a given movie-based visualization consists of only a relatively small portion of scenes from a corresponding movie.

19. The method as defined in claim 14, wherein the genre classification of the music is automatically further determined, at least in part, from one or more of:
timbral texture analysis,
beat structure analysis,
statistical analysis,
melodic pattern clustering,
pitch clustering, or
rhythm clustering.

20. The method as defined in claim 14, the method further comprising enabling the first user to share the first visualization with others via a social networking system.

21. The method as defined in claim 14, wherein the first visualization is selected based at least in part on feedback provided by other users.

22. The method as defined in claim 14, the method further comprising providing a collaboration system configured to enable two or more users to collaborate on a visualization,
wherein a given collaborating user is enabled to specify a source for audio media and visual media to be used in the visualization, and to edit the audio media to be used in the visualization by:
(a) changing the tempo, or
(b) the beats per minute, or
(c) warping audio tracks, or
(d) adjusting beat phase, or
(e) mixing two or more audio sources, or
(f) editing audio track amplitudes at selected points, or
(g) equalize the tracks, or
(h) performing sound wave mapping, or
(i) and combination of (a), (b), (c), (d), (e), (f), (g), or (h);
and to edit the visual media to be used in the visualization by:
matching visual media frames with transitions of the audio media to be used in the visualization;
matching the audio media to be used in the visual media with the visual media frames;
cropping images,
deleting or duplicating frames,
mixing frames,
changing frame rates,
changing image colors,
changing image tints,
changing image sharpness.

23. A system comprising:
a data store configured to store computer-executable instructions; and
a processor comprising hardware in communication with the data store, the processor configured to execute the computer-executable instructions to at least:
provide a first user interface enabling a first user to indicate on which of a set of networked devices a first visualization is to be presented by,
wherein the user can selectively specify that the first visualization is to be presented on a plurality of networked devices or on a single device;
identify a set of devices that the first visualization is to be presented on based at least in part on a user specification provided via the first user interface;
maintain a library of sequences of images;
store genre information in association with respective sequences of images;
detect music currently being played by at least one device in the set of devices;
access genre information and tempo information for the detected music currently being played by at least one device in the set of devices wherein the genre information for the detected music is determined based at least in part on feature extraction performed on the detected music;
access genre information for one or more of the sequences of images, wherein a given sequence of images includes images mixed together or images displayed at different rates, or both images mixed together and images displayed at different rates;
based at least in part on:
the genre information and tempo information for the detected music currently being played by at least one device in the set of devices, and on the accessed genre information associated with the one or more sequences of images,
select a first sequence of images for a first visualization to be displayed on the set of user devices as an accompaniment to the music currently being played by the at least one device in the set of devices;
cause the first visualization to be streamed by a visualization server to, and presented on the set of user devices as an accompaniment to the music currently being played by the at least one device in the set of devices, wherein the first visualization correlates with a mood of the music.

24. The system as defined in claim 23, wherein the selection of the first sequence of images for the first visualization is based in part on information accessed from an account record of the user.

25. The system as defined in claim 23, wherein the selection of the first sequence of images for the first visualization is based in part on information accessed from a thermal imaging sensor.

26. The system as defined in claim 23, wherein the selection of the first sequence of images for the first visualization is based in part on movements of one or more people detected via a movement sensor at a first location, ambient light at the first location, colors of one or more objects at the first location.

27. The system as defined in claim 23, wherein the processor is configured to execute the computer-executable instructions to provide an interface via which the user can select a visualization channel from a first set of visualization channels, the first set of visualization channels including at least one visualization channel that comprises computer generated abstract visualizations and at least one channel of movie-based visualizations wherein a given movie-based visualization consists of only a relatively small portion of scenes from a corresponding movie.

28. The system as defined in claim 23, wherein the genre classification of the music is automatically further determined, at least in part, from one or more of:
timbral texture analysis,
beat structure analysis,
statistical analysis,
melodic pattern clustering,
pitch clustering, or
rhythm clustering.

29. The system as defined in claim 23, wherein the first visualization is selected based in part on feedback provided by other users.

30. A non-transitory computer-readable storage medium storing computer executable instructions that when executed by a processor perform operations comprising:
providing a first user interface enabling a first user to indicate on which of a set of networked devices at least one visualization is to be presented by,
wherein the user can selectively specify that the at least one visualization is to be presented on a plurality of networked devices or on a single device;
identifying a set of devices that the at least one visualization is to be presented on based at least in part on a user specification provided via the first user interface;
maintaining a library of sequences of images;
storing genre information in association with respective sequences of images;
detecting music currently being played by at least one device in the set of devices;
accessing genre information and tempo information for the detected music currently being played by at least one device in the set of devices wherein the genre information for the detected music is determined based at least in part on feature extraction performed on the detected music;
accessing genre information for one or more of the sequences of images, wherein a given sequence of images includes images mixed together or images displayed at different rates, or both images mixed together and images displayed at different rates;
based at least in part on:
the genre information and tempo information for the detected music currently being played by at least one device in the set of devices, and on the accessed genre information associated with the one or more sequences of images,
selecting a first sequence of images for a first visualization to be displayed on the set of user devices as an accompaniment to the music currently being played by the at least one device in the set of devices;
causing the first visualization to be streamed by a visualization server to, and presented on the set of user devices as an accompaniment to the music currently being played by the at least one device in the set of devices, wherein the first visualization correlates with a mood of the music.
